(19) United States
(12) Patent Application Publication
(10) Pub. No.: US 2016/0190954 A1
(43) Pub. Date: Jun. 30, 2016

(54) METHOD AND SYSTEM FOR BRIDGELESS AC-DC CONVERTER

(71) Applicant: Avogy, Inc., San Jose, CA (US)

(72) Inventor: Alberto Doronzo, San Jose, CA (US)

(21) Appl. No.: 14/983,050

(22) Filed: Dec. 29, 2015

Related U.S. Application Data
(60) Provisional application No. 62/098,621, filed on Dec. 31, 2014.

(51) Int. Cl. H02M 7/04

(52) U.S. Cl. CPC H02M 7/04

(57) ABSTRACT

An AC-DC converter configured to convert an input AC signal to an output DC signal is disclosed. The AC-DC converter includes an inductor and first and second transistors, where the inductor and first and second transistors are connected in series with one another. The input AC signal is applied across the series connected inductor and first and second transistors, and the series connected inductor and first and second transistors is configured to generate a secondary AC signal based on the AC input signal. The AC-DC converter also includes a rectifier, configured to rectify a signal based on the secondary AC signal to generate a substantially DC output signal based on the AC input signal.

### CROSS-REFERENCES TO RELATED APPLICATIONS

This application is a claims the benefit of U.S. Provisional Patent Application No. 62/098,621, filed Dec. 31, 2014. The disclosure is hereby incorporated by reference in its entirety.

### BACKGROUND OF THE INVENTION

Power electronics are widely used in a variety of applications. Power electronic devices are commonly used in circuits to modify the form of electrical energy and/or to modify from one voltage level to another, for example, AC to DC or DC to DC. Such devices can operate over a wide range of power levels, from milliwatts in mobile devices to hundreds of megawatts in high voltage power transmission systems, and at increasingly high frequencies for modern electronic applications. Despite the progress made in power electronics, there is a need in the art for improved electronics systems for achieving higher power conversion efficiencies and methods of operating the same.

### SUMMARY OF THE INVENTION

The present invention relates generally to electronic devices. More specifically, the present invention relates to AC-DC conversion circuit architectures.

One inventive aspect is an AC-DC converter configured to convert an input AC signal to an output DC signal. The AC-DC converter includes an inductor and first and second transistors, where the inductor and first and second transistors are connected in series with one another. The input AC signal is applied across the series connected inductor and first and second transistors, and the series connected inductor and first and second transistors is configured to generate a secondary AC signal based on the AC input signal. The AC-DC converter also includes a rectifier, configured to rectify a signal based on the secondary AC signal to generate a substantially DC output signal based on the AC input signal.

Numerous benefits are achieved by way of the present invention over conventional techniques. For example, embodiments of the present invention utilize gallium-nitride (GaN)-based transistors that have small parasitics, which enable resonant operation of the circuit. In addition, between the AC input and the DC output there is only one rectification stage. For example, in some embodiments, the input AC signal drives a power transformer without rectification. This results in fewer components, fewer losses, and higher power factor. In some embodiments, even for high power conversion, no power factor correction is needed. Various non-limiting embodiments of the present invention, along with many advantages and features, are described in more detail in conjunction with the text below and attached figures.

### BRIEF DESCRIPTION OF THE DRAWINGS

FIG. 1 is a schematic diagram of an AC-DC converter circuit.

FIG. 2 is a simplified schematic diagram of an AC-DC converter circuit.

FIG. 3 is a simplified schematic diagram of a circuit including logic driving circuits.

FIGS. 4A and 4B are simplified timing diagrams illustrating resonant operation of AC-DC converter circuit.

FIG. 5 is a simplified schematic diagram of a circuit including a logic driving circuit.

FIG. 6 is a simplified schematic diagram of a circuit including logic driving circuit 200, which is connected to AC-DC converter circuit similar to AC-DC converter circuit.

FIGS. 7A and 7B are simplified timing diagrams illustrating resonant operation of AC-DC converter circuit.

FIG. 8 is a simplified schematic diagram of an AC-DC converter circuit.

FIG. 9 is a simplified schematic diagram of a circuit including logic driving circuits.

FIGS. 10A and 10B are simplified timing diagrams illustrating resonant operation of AC-DC converter circuit.

FIG. 11 is a simplified schematic diagram of a circuit including logic driving circuit.

FIGS. 12A and 12B are simplified timing diagrams illustrating resonant operation of the AC-DC converter circuit.

FIG. 13 is a simplified schematic diagram of an AC-DC converter circuit.

FIG. 14 is a simplified schematic diagram of a circuit including logic driving circuits.

FIGS. 15A and 15B are simplified timing diagrams illustrating resonant operation of AC-DC converter circuit.

FIG. 16 is a simplified schematic diagram of a circuit including logic driving circuit.

FIG. 17 is a simplified schematic diagram of a circuit including logic driving circuit.

FIGS. 18A and 18B are simplified timing diagrams illustrating resonant operation of the AC-DC converter circuit.

FIG. 19 is a simplified schematic diagram of an AC-DC converter circuit.

FIG. 20 is a simplified schematic diagram of a circuit including logic driving circuits.

FIGS. 21A and 21B are simplified timing diagrams illustrating resonant operation of AC-DC converter circuit.

FIG. 22 is a simplified schematic diagram of a circuit including logic driving circuit.

FIGS. 23A and 23B are simplified timing diagrams illustrating resonant operation of the AC-DC converter circuit.

FIG. 24 is a simplified schematic diagram of a clamp circuit.

### DETAILED DESCRIPTION OF SPECIFIC EMBODIMENTS

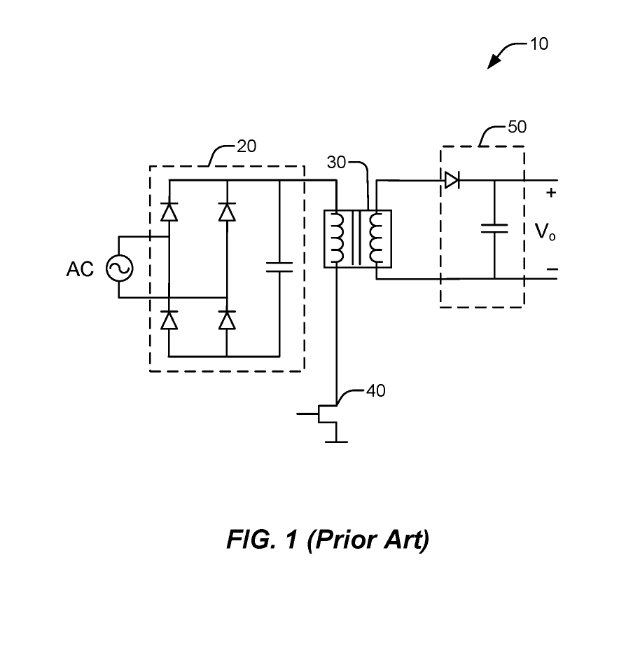

FIG. 1 is a schematic diagram of an AC-DC converter circuit 10. AC-DC converter circuit 10 includes input rectifier 20, power transformer 30, main switch 40, and output rectifier 50.

Input rectifier 20 presents a substantially DC voltage to the primary side of power transformer 30. In addition, input rectifier 20 sources a current at the substantially DC voltage to the primary inductor of power transformer 30 according to the state of main switch 40.

Main switch 40 is driven with a pulse width modulated (PWM) signal such that the ratio of on time to off time of main switch 40 corresponds with the duty cycle of the PWM signal. Accordingly, an AC signal having an amplitude corresponding with the DC voltage presented to the power transformer by input rectifier 20, a frequency equal to the frequency of the PWM signal, and a duty cycle corresponding with the duty cycle of the PWM signal is driven across the primary inductor of the power transformer 30. As a result the power transferred through the power transformer to the output is regulated by the PWM signal.

Output rectifier 50 outputs a substantially DC voltage based on the AC signal generated by the secondary inductor of the power transformer 30.

Because of the topology of the AC-DC converter circuit 10, the power conversion produced thereby experiences losses from the input rectifier 20. In addition, the power conversion produced AC-DC converter circuit 10 experiences a decrease in power conversion because of the components of the input rectifier 20.

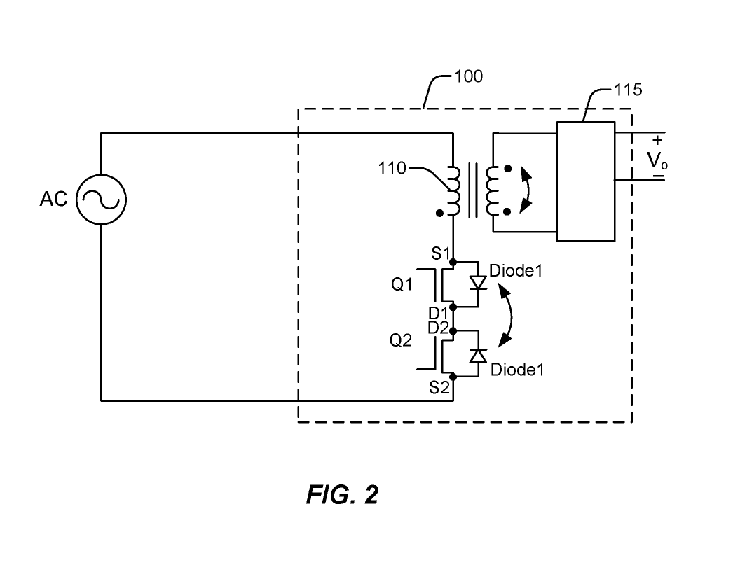

FIG. 2 is a simplified schematic diagram of an AC-DC converter circuit 100 with a transformer-FET-FET configuration according to an embodiment of the present invention. Receiving an AC input signal, the AC-DC converter circuit 100 generates a secondary AC signal which is rectified by rectifier 115 to generate a DC output voltage across Vo. As illustrated in FIG. 2, an AC source voltage is applied across the series connected primary inductor of power transformer 110 and transistors Q1 and Q2. In response to the AC source voltage, the series connected primary inductor of power transformer 110 and transistors Q1 and Q2 generates the secondary AC signal. Body diodes Diode1 and Diode2 are illustrated along with the source S1, gate G1, and drain D1 of transistor Q1 and the source S2, gate G2, and drain D2 of transistor Q2.

Rectifier 115 may comprise any rectification circuit. For example, rectifier 115 may comprise any of: a single diode rectifier, a full-bridge rectifier, a voltage doubler rectifier, and another type of rectifier.

The AC-DC converter in FIG. 2 does not have an input rectifier, such as input rectifier 20 of AC-DC converter circuit 10, illustrated in FIG. 1. In some embodiments, the transistors Q1 and Q2 are GaN-based transistors that have small parasitics, which enable resonant operation of the circuit.

As shown, the AC-DC converter circuit 100 includes rectifier 115, which receives the AC output from the power transformer 110 and generates a substantially DC signal across Vo based on the received AC output.

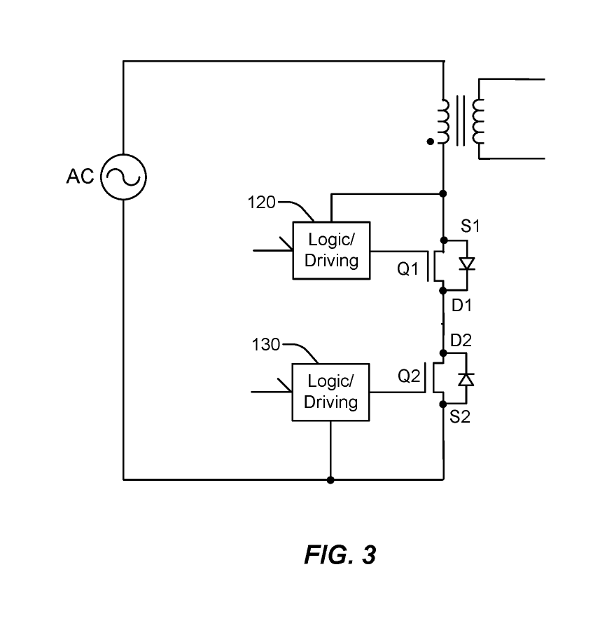

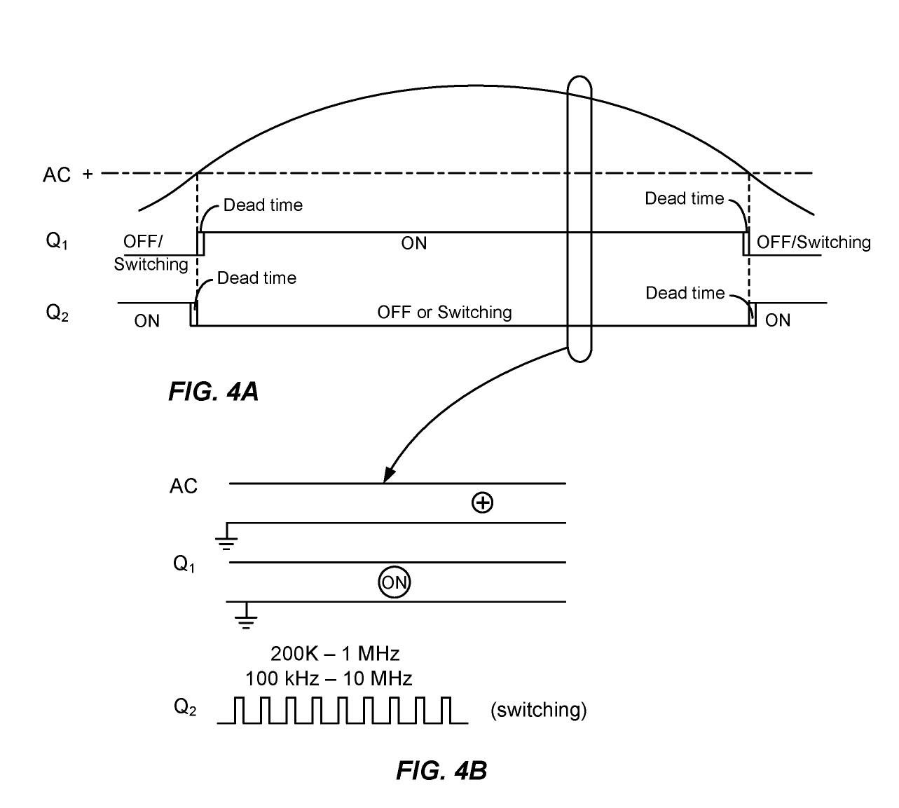

The operation of AC-DC converter circuit 100 is discussed below with reference to FIGS. 3 and 4A/4B.

FIG. 3 is a simplified schematic diagram of a circuit including logic driving circuits 120 and 130, which are connected to AC-DC converter circuit 100 according to an embodiment of the present invention. As shown, logic driving circuit 120 is configured to drive transistor Q1 and logic driving circuit 130 is configured to drive transistor Q2. In some embodiments, logic driving circuits 120 and 130 are substantially identical.

As described with reference to FIGS. 4A and 4B below, the transistors Q1 and Q2 of AC-DC converter circuit 100 are driven according to the following protocol.

| AC | Q1 | Q2 |
|---|---|---|
| Positive Portion of Cycle | ON | PWM Switching |
| Negative Portion of Cycle | PWM Switching | ON |

FIG. 4A is a simplified timing diagram illustrating resonant operation of AC-DC converter circuit 100 driven by logic driving circuits 120 and 130, as illustrated in FIG. 3. As illustrated in FIG. 4A, on the positive portion of the AC source cycle, logic driving circuit 120 turns on transistor Q1 with a PWM signal and logic driving circuit 130 turns off transistor Q2. Referring to FIG. 4A, when the AC source transitions from negative to positive, a short dead time is present for Q1 where Q1 is off for a short duration following the transition. Q2 is also off during a dead time preceding the transition. This ensures that Q1 and Q2 are not both on at the same time.

In some embodiments, Q1 and Q2 dead times overlap such that both transistors Q1 and Q2 are off at zero crossings of the AC source to ensure that transistors Q1 and Q2 are not both on at the same time around transitions from the negative to the positive portion of the cycle. Other dead time transitions may also be implemented which ensure that transistors Q1 and Q2 are not both on at the same time around transitions from the negative portion to the positive portion of the cycle.

In this embodiment, as the AC source transitions from the positive portion of the cycle to the negative portion of the cycle, dead times are similarly provided for transistors Q1 and Q2. During the transition from the positive to the negative portion of the cycle, transistor Q1 is off during a short time preceding the transition and transistor Q2 is off for a short time following the transition. Other dead time transitions may also be implemented which ensure that transistors Q1 and Q2 are not both on at the same time around transitions from the positive to the negative portion of the cycle.

FIG. 4B is an expanded timing diagram illustrating an expanded time period of the timing diagram of FIG. 4A. As illustrated in FIG. 4B, during the positive portion of the AC cycle, in response to respective PWM signals from logic driving circuits 120 and 130, transistor Q1 is held in an on state and transistor Q2 is alternating between on and off states at a frequency than ranges from about 100 kHz to about 10 MHz. In a particular embodiment, the switching frequency of transistor Q2 is from about 200 kHz to about 1 MHz. In alternative embodiments, Q2 switches between on and off states at other frequencies.

Corresponding switching behavior is applied to transistor Q1 during the negative portion of the AC cycle, when transistor Q2 is held in an on state and transistor Q1 alternates between on and off states.

Because of the high switching frequencies enabled by the use of GaN transistors as transistors Q1 and Q2, embodiments of the present invention may use air core transformers in some implementations in place of solid core (e.g., ferrite core) transformers. In alternative embodiments, solid core transformers may be used. The transformer used is not limited by the invention.

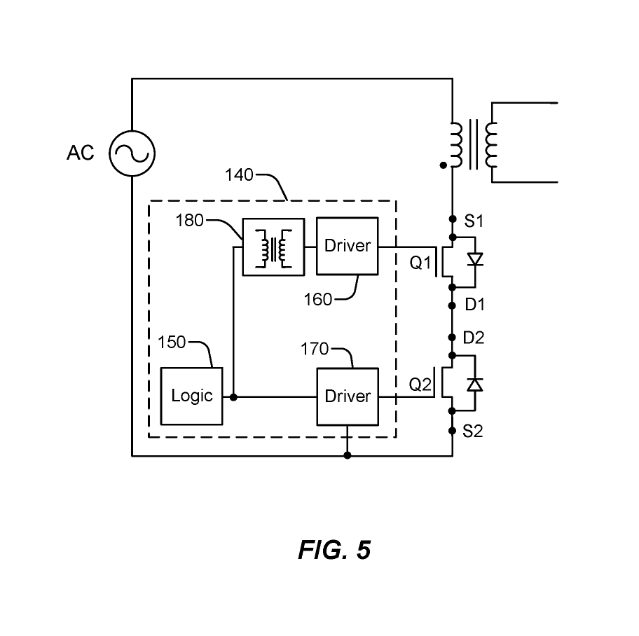

FIG. 5 is a simplified schematic diagram of a circuit including logic driving circuit 140, which is connected to AC-DC converter circuit 100 according to an embodiment of the present invention. In the embodiment illustrated in FIG. 5, a single logic circuit 150 is used to drive two driver circuits 160 and 170.

Logic circuit 150 is configured to generate a logic signal corresponding with the PWM signals to be provided to transistors Q1 and Q2.

As shown, the generated logic signal is provided to driver circuits 160 and 170, where the generated logic signal is provided to driver circuit 160 via isolation device 180. The isolation device 180 can be magnetic, optical, or the like.

Accordingly, in the embodiment illustrated in FIG. 5, transistors Q1 and Q2 are driven by two driver circuits 160 and 170, which are driven by a single logic circuit 150.

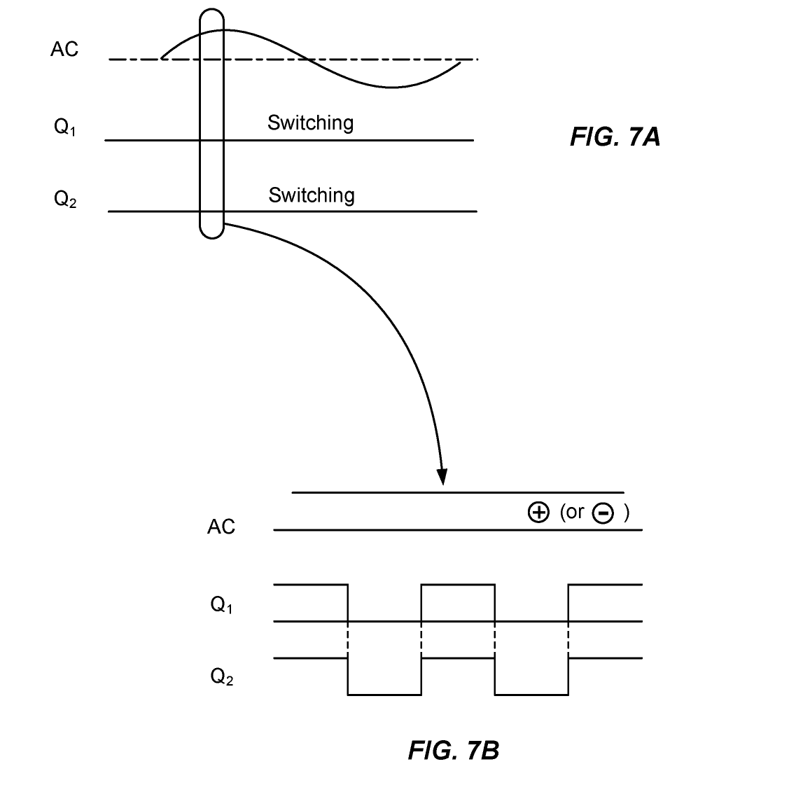

The operation of the embodiment illustrated in FIG. 5 is discussed below with reference to FIGS. 7A and 7B.

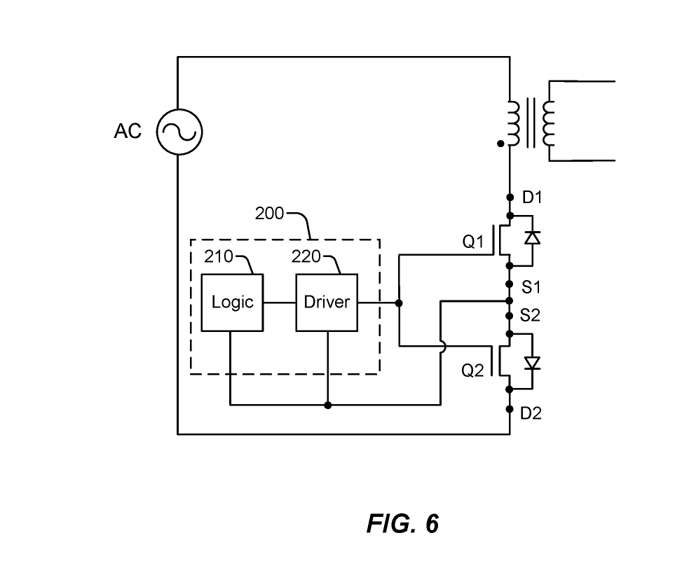

FIG. 6 is a simplified schematic diagram of a circuit including logic driving circuit 200, which is connected to AC-DC converter circuit similar to AC-DC converter circuit 100 according to an embodiment of the present invention. In the embodiment illustrated in FIG. 6, the transistors Q1 and Q2 are configured in a source-to-source configuration. In this configuration, the source S1 of transistor Q1 is connected to the source S2 of transistor Q2. The drain D1 of transistor D1 is connected to the power transformer and the drain D2 of transistor Q2 is connected to ground. As shown, a single logic circuit 210 is used to drive a single driver circuit 220.

Logic circuit 210 is configured to generate a logic signal corresponding with the PWM signals to be provided to transistors Q1 and Q2. As shown, the generated logic signal is provided to driver circuit 220, which drives both transistors Q1 and Q2.

Accordingly, in the embodiment illustrated in FIG. 6, transistors Q1 and Q2 are driven by one driver circuit 220, which is driven by a single logic circuit 210.

The operation of the embodiment illustrated in FIG. 6 is discussed below with reference to FIGS. 7A and 7B, which are simplified timing diagrams illustrating resonant operation of the AC-DC converter circuit.

As described in relation to FIGS. 7A and 7B, the transistors Q1 and Q2 in FIGS. 5 and 6 are driven according to the following protocol.

| | | |
|---|---|---|
| AC | Q1 | Q2 |

| | |
|---|---|
| Positive Portion of Cycle | Synchronized PWM Switching |
| Negative Portion of Cycle | Synchronized PWM Switching |

As illustrated in FIG. 7A, both transistors Q1 and Q2 are switching during both the positive portion of the AC cycle as well as during the negative portion of the AC cycle.

FIG. 7B is an expanded timing diagram illustrating an expanded time period of the timing diagram illustrated in FIG. 7A. As illustrated in FIG. 7B, which corresponds to a positive portion of the AC cycle, the transistors are switched on and off in a synchronous manner (i.e. substantially in phase with each other). As shown, the edges of the signals that are provided to the gates are substantially aligned in time. Similar switching behavior is generated during the negative portion of the AC cycle. Switching frequencies as discussed in relation to FIG. 4B are applicable to the switching behavior illustrated in FIG. 4B.

As a result of the topology of AC-DC converter circuit 100, fewer components are used that in conventional AC-DC power converter circuits, there is less power loss, and a power factor correction circuit is not necessary, and therefore, is not used.

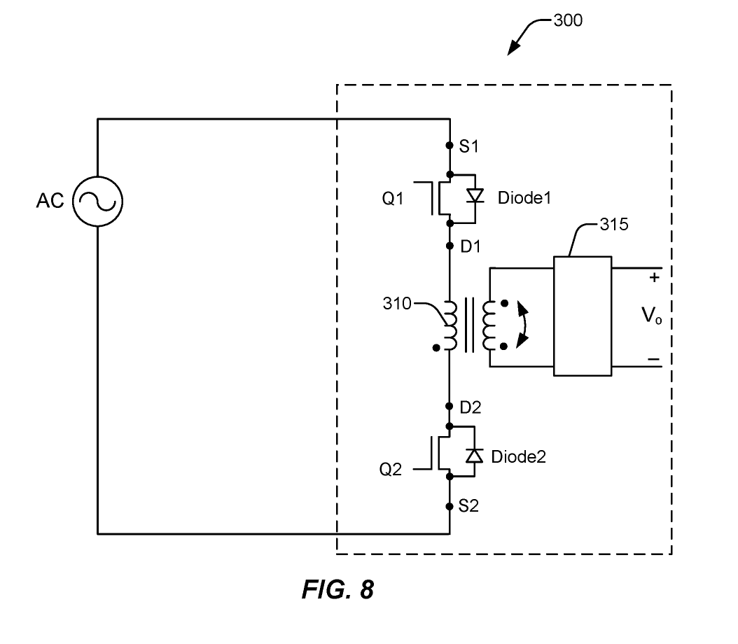

FIG. 8 is a simplified schematic diagram of an AC-DC converter circuit 300 with a FET-transformer-FET configuration according to an embodiment of the present invention. Receiving an AC input, the AC-DC converter circuit 300 generates an AC signal which is rectified by rectifier 315 to generate DC output across Vo. As illustrated in FIG. 8, an AC source voltage is applied across the series connected primary inductor of power transformer 310 and transistors Q1 and Q2. In response to the AC source voltage, the series connected primary inductor of power transformer 310 and transistors Q1 and Q2 generates the secondary AC signal. Body diodes Diode1 and Diode2 are illustrated along with the source S1, gate G1, and drain D1 of transistor Q1 and the source S2, gate G2, and drain D2 of transistor Q2.

Rectifier 315 may comprise any rectification circuit. For example, rectifier 315 may comprise any of: a single diode rectifier, a full-bridge rectifier, a voltage doubler rectifier, and another type of rectifier.

The AC-DC converter in FIG. 8 does not have an input rectifier, such as input rectifier 20 of AC-DC converter circuit 10, illustrated in FIG. 1. In some embodiments, the transistors Q1 and Q2 are GaN-based transistors that have small parasitics, which enable resonant operation of the circuit.

As shown, the AC-DC converter circuit 300 includes rectifier 315, which receives the AC output of the power transformer 310 and generates a substantially DC signal across Vo based on the received AC output.

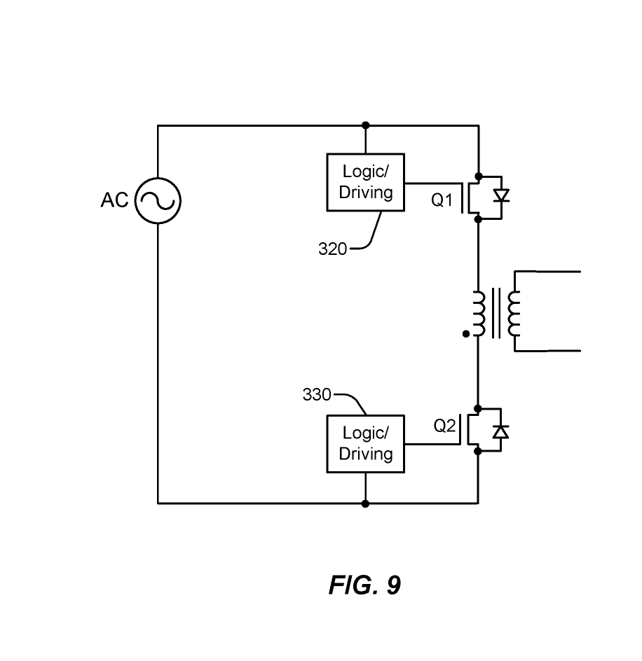

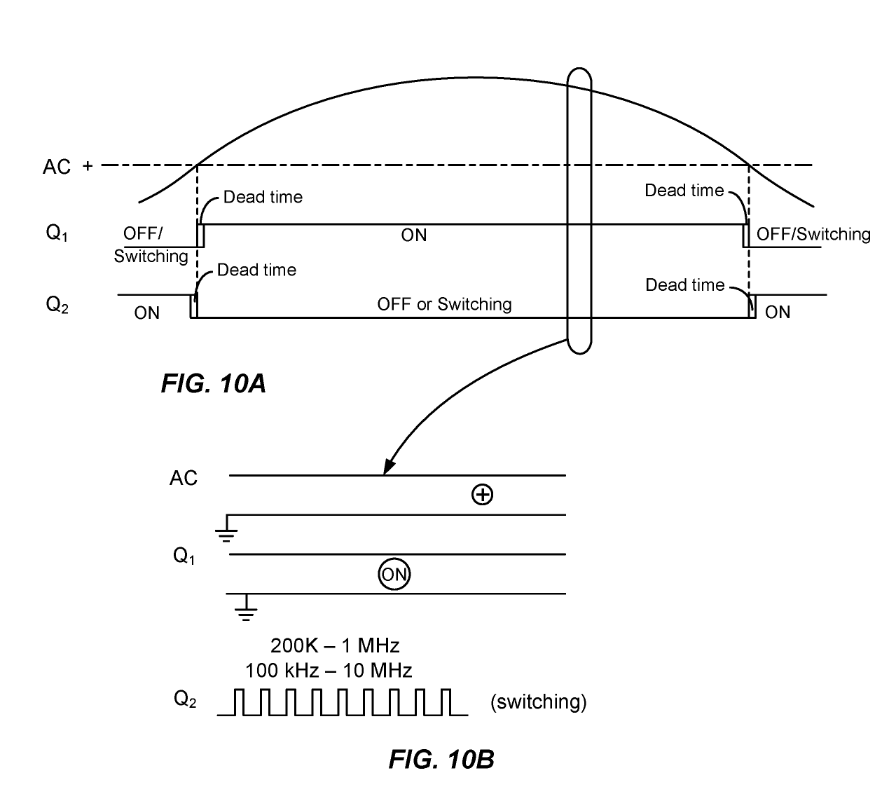

The operation of AC-DC converter circuit 300 is discussed below with reference to FIGS. 9 and 10A/10B.

FIG. 9 is a simplified schematic diagram of a circuit including logic driving circuits 320 and 330, which are connected to AC-DC converter circuit 300 according to an embodiment of the present invention. As shown, logic driving circuit 320 is configured to drive transistor Q1 and logic driving circuit 330 is configured to drive transistor Q2. In some embodiments, logic driving circuits 320 and 330 are substantially identical.

As described with reference to FIGS. 10A and 10B below, the transistors Q1 and Q2 of AC-DC converter circuit 300 are driven according to the following protocol.

| AC | Q1 | Q2 |
|---|---|---|
| Positive Portion of Cycle | ON | PWM Switching |
| Negative Portion of Cycle | PWM Switching | ON |

FIG. 10A is a simplified timing diagram illustrating resonant operation of AC-DC converter circuit 300 driven by logic driving circuits 320 and 330, as illustrated in FIG. 9. As illustrated in FIG. 10A, on the positive portion of the AC source cycle, logic driving circuit 320 turns on transistor Q1 with a PWM signal and logic driving circuit 330 turns off transistor Q2. Referring to FIG. 10A, when the AC source transitions from negative to positive, a short dead time is present for Q1 where Q1 is off for a short duration following the transition. Q2 is also off during a dead time preceding the transition. This ensures that Q1 and Q2 are not both on at the same time.

In some embodiments, Q1 and Q2 dead times overlap such that both transistors Q1 and Q2 are off at zero crossings of the AC source to ensure that transistors Q1 and Q2 are not both on at the same time around transitions from the negative to the positive portion of the cycle. Other dead time transitions may also be implemented which ensure that transistors Q1 and Q2 are not both on at the same time around transitions from the negative to the positive portion of the cycle.

In this embodiment, as the AC source transitions from the positive portion of the cycle to the negative portion of the cycle, dead times are similarly provided for transistors Q1 and Q2. During the transition from the positive to the negative portion of the cycle, transistor Q1 is off during a short time preceding the transition and transistor Q2 is off for a short time following the transition. Other dead time transitions may also be implemented which ensure that transistors Q1 and Q2 are not both on at the same time around transitions from the positive portion to the negative portion of the cycle.

FIG. 10B is an expanded timing diagram illustrating an expanded time period of the timing diagram of FIG. 10A. As illustrated in FIG. 10B, during the positive portion of the AC cycle, in response to respective PWM signals from logic driving circuits 320 and 330, transistor Q1 is held in an on state and transistor Q2 is alternating between on and off states at a frequency than ranges from about 100 kHz to about 10 MHz. In a particular embodiment, the switching frequency of transistor Q2 is from about 200 kHz to about 1 MHz. In alternative embodiments, Q2 switches between on and off states at other frequencies.

Corresponding switching behavior is applied to transistor Q1 during the negative portion of the AC cycle, when transistor Q2 is held in an on state and transistor Q1 alternates between on and off states.

Because of the high switching frequencies enabled by the use of GaN transistors as transistors Q1 and Q2, embodiments of the present invention may use air core transformers in some implementations in place of solid core (e.g., ferrite core) transformers. In alternative embodiments, solid core transformers may be used. The transformer used is not limited by the invention.

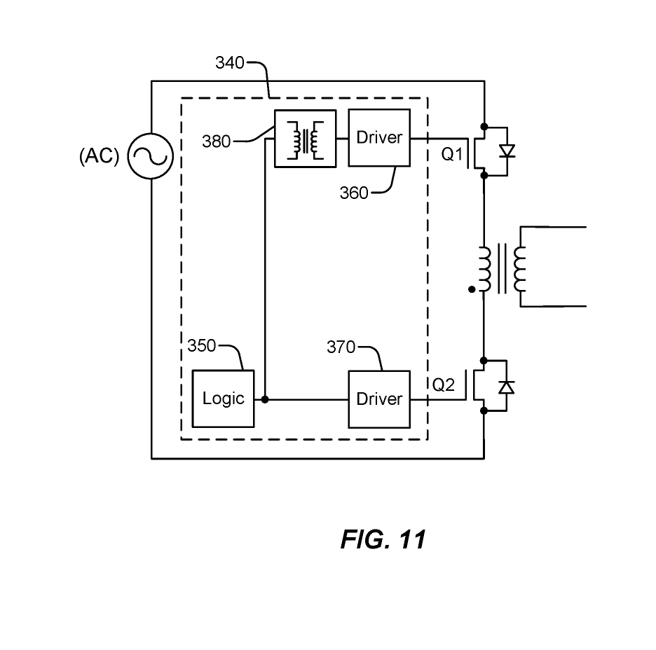

FIG. 11 is a simplified schematic diagram of a circuit including logic driving circuit 340, which is connected to AC-DC converter circuit 300 according to an embodiment of the present invention. In the embodiment illustrated in FIG. 11, a single logic circuit 350 is used to drive two driver circuits 360 and 370.

Logic circuit 350 is configured to generate a logic signal corresponding with the PWM signals to be provided to transistors Q1 and Q2.

As shown, the generated logic signal is provided to driver circuits 360 and 370, where the generated logic signal is provided to driver circuit 360 via isolation device 380. The isolation device 380 can be magnetic, optical, or the like.

Accordingly, in the embodiment illustrated in FIG. 11, transistors Q1 and Q2 are driven by two driver circuits 360 and 370, which are driven by a single logic circuit 350.

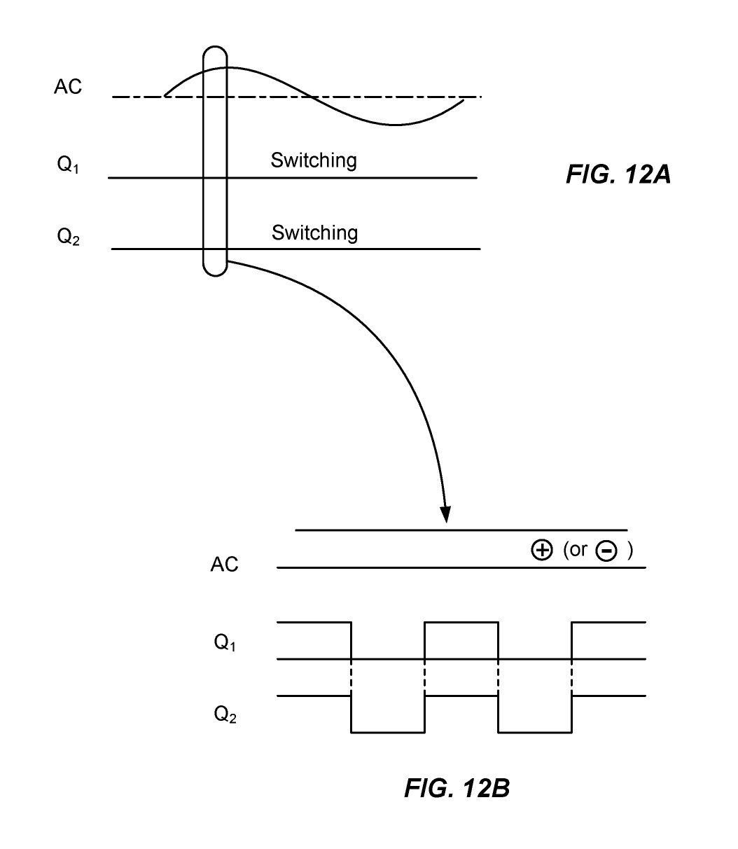

The operation of the embodiment illustrated in FIG. 11 is discussed below with reference to FIGS. 12A and 12B, which are simplified timing diagrams illustrating resonant operation of the AC-DC converter circuit. In the operation of the embodiment illustrated in FIG. 11, transistors Q1 and Q2 are driven according to the following protocol.

| | | |
|---|---|---|
| AC | Q1 | Q2 |

| | |
|---|---|
| Positive Portion of Cycle | Synchronized PWM Switching |
| Negative Portion of Cycle | Synchronized PWM Switching |

As illustrated in FIG. 12A, both transistors Q1 and Q2 are switching during both the positive portion of the AC cycle as well as during the negative portion of the AC cycle.

FIG. 12B is an expanded timing diagram illustrating an expanded time period of the timing diagram illustrated in FIG. 12A. As illustrated in FIG. 12B, which corresponds to a positive portion of the AC cycle, the transistors are switched on and off in a synchronous manner (i.e. substantially in phase with each other). As shown, the edges of the signals that are provided to the gates are substantially aligned in time. Similar switching behavior is generated during the negative portion of the AC cycle. Switching frequencies as discussed in relation to FIG. 10B are applicable to the switching behavior illustrated in FIG. 10B.

As a result of the topology of AC-DC converter circuit 300, fewer components are used that in conventional AC-DC power converter circuits, there is less power loss, and a power factor correction circuit is not necessary, and therefore, is not used.

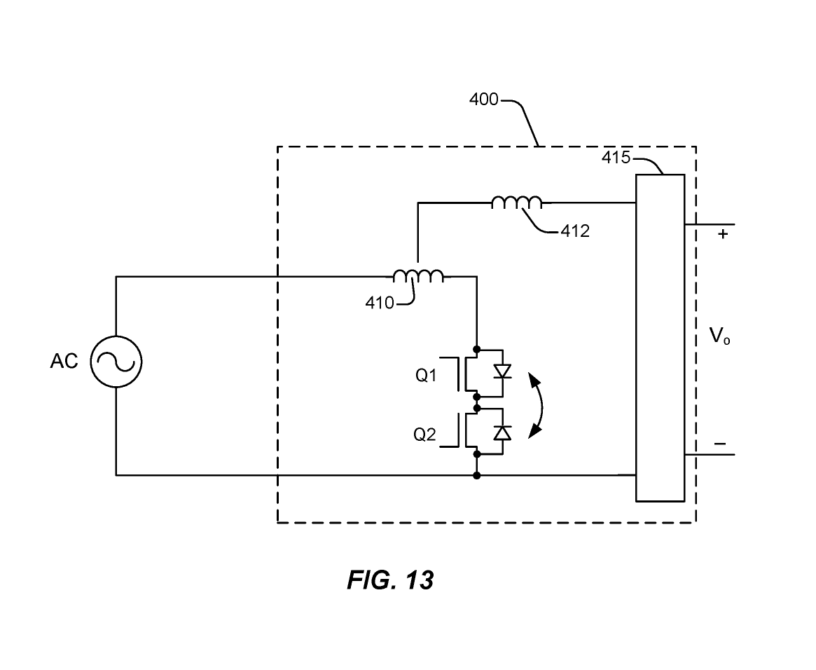

FIG. 13 is a simplified schematic diagram of an AC-DC converter circuit 400 with an inductor FET-FET configuration according to an embodiment of the present invention. Receiving an AC input signal, the AC-DC converter circuit 400 generates a secondary AC signal which is rectified by rectifier 415 to generate a DC output voltage across Vo. As illustrated in FIG. 13, an AC source voltage is applied across the series connected tapped inductor 410 and transistors Q1 and Q2. In response to the AC source voltage, the series connected tapped inductor 410 and transistors Q1 and Q2 generates the secondary AC signal. Body diodes Diode1 and Diode2 are illustrated along with the source S1, gate G1, and drain D1 of transistor Q1 and the source S2, gate G2, and drain D2 of transistor Q2.

Rectifier 415 may comprise any rectification circuit. For example, rectifier 415 may comprise any of: a single diode rectifier, a full-bridge rectifier, a voltage doubler rectifier, and another type of rectifier.

In this embodiment, AC-DC converter circuit 400 includes an inductor 412 between inductor 410 and rectifier 415. As understood by those of skill in the art, the sizes of inductors 410 and 412 may be selected to maximize resonance.

The AC-DC converter in FIG. 13 does not have an input rectifier, such as input rectifier 20 of AC-DC converter circuit 10, illustrated in FIG. 1. In some embodiments, the transistors Q1 and Q2 are GaN-based transistors that have small parasitics, which enable resonant operation of the circuit.

As shown, the AC-DC converter circuit 400 includes rectifier 415, which receives the AC output from inductor 410 and generates a substantially DC signal across Vo based on the received AC output.

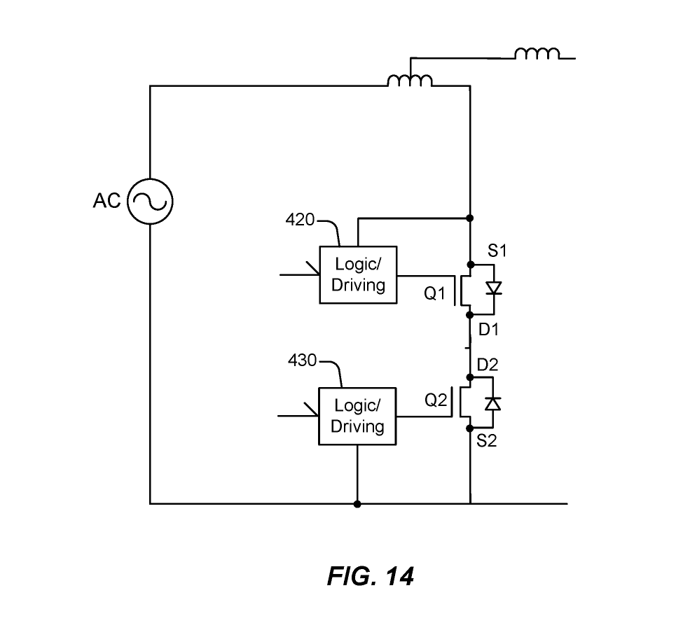

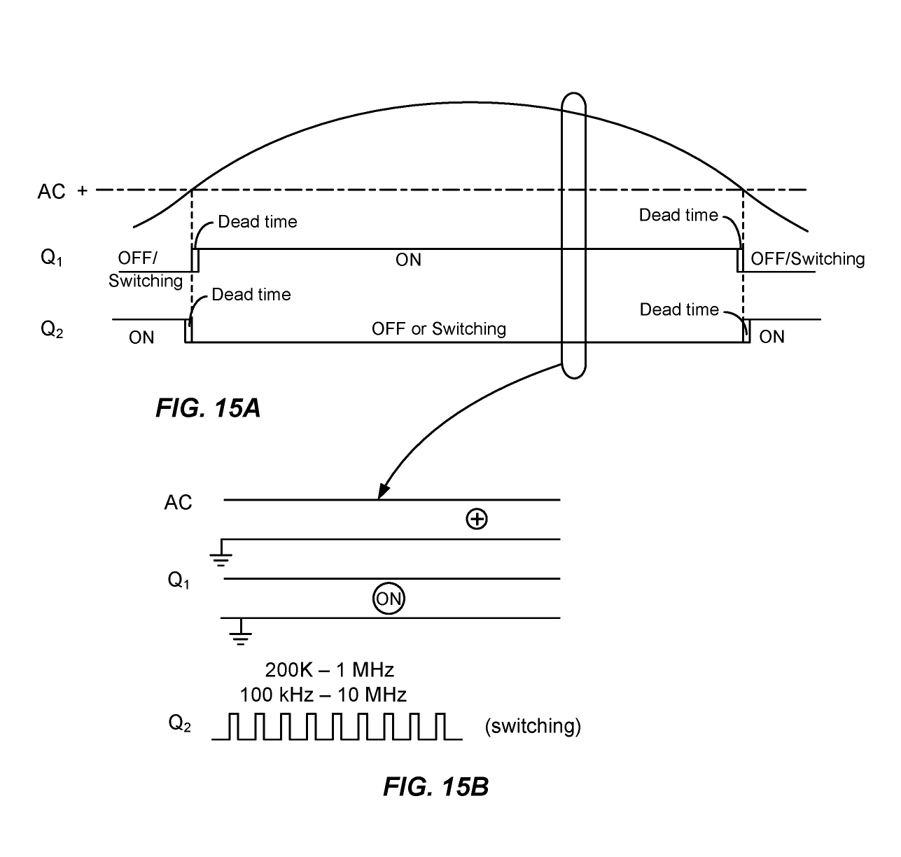

The operation of AC-DC converter circuit 400 is discussed below with reference to FIGS. 14 and 15A/15B.

FIG. 14 is a simplified schematic diagram of a circuit including logic driving circuits 420 and 430, which are connected to AC-DC converter circuit 400 according to an embodiment of the present invention. As shown, logic driving circuit 420 is configured to drive transistor Q1 and logic driving circuit 430 is configured to drive transistor Q2. In some embodiments, logic driving circuits 420 and 430 are substantially identical.

As described with reference to FIGS. 15A and 15B below, the transistors Q1 and Q2 of AC-DC converter circuit 400 are driven according to the following protocol.

| AC | Q1 | Q2 |
|---|---|---|
| Positive Portion of Cycle | ON | PWM Switching |
| Negative Portion of Cycle | PWM Switching | ON |

FIG. 15A is a simplified timing diagram illustrating resonant operation of AC-DC converter circuit 400 driven by logic driving circuits 420 and 430, as illustrated in FIG. 14. As illustrated in FIG. 15A, on the positive portion of the AC source cycle, logic driving circuit 420 turns on transistor Q1 with a PWM signal and logic driving circuit 430 turns off transistor Q2. Referring to FIG. 15A, when the AC source transitions from negative to positive, a short dead time is present for Q1 where Q1 is off for a short duration following the transition. Q2 is also off during a dead time preceding the transition. This ensures that Q1 and Q2 are not both on at the same time.

In some embodiments, Q1 and Q2 dead times overlap such that both transistors Q1 and Q2 are off at zero crossings of the AC source to ensure that transistors Q1 and Q2 are not both on at the same time around transitions from the negative to the positive portion of the cycle. Other dead time transitions may also be implemented which ensure that transistors Q1 and Q2 are not both on at the same time around transitions from the negative to the positive portion of the cycle.

In this embodiment, as the AC source transitions from the positive portion of the cycle to the negative portion of the cycle, dead times are similarly provided for transistors Q1 and Q2. During the transition from the positive to the negative portion of the cycle, transistor Q1 is off during a short time preceding the transition and transistor Q2 is off for a short time following the transition. Other dead time transitions may also be implemented which ensure that transistors Q1 and Q2 are not both on at the same time around transitions from the positive portion to the negative portion of the cycle.

FIG. 15B is an expanded timing diagram illustrating an expanded time period of the timing diagram of FIG. 15A. As illustrated in FIG. 15B, during the positive portion of the AC cycle, in response to respective PWM signals from logic driving circuits 420 and 430, transistor Q1 is held in an on state and transistor Q2 is alternating between on and off states at a frequency than ranges from about 100 kHz to about 10 MHz. In a particular embodiment, the switching frequency of transistor Q2 is from about 200 kHz to about 1 MHz. In alternative embodiments, Q2 switches between on and off states at other frequencies.

Corresponding switching behavior is applied to transistor Q1 during the negative portion of the AC cycle, when transistor Q2 is held in an on state and transistor Q1 alternates between on and off states.

Because of the high switching frequencies enabled by the use of GaN transistors as transistors Q1 and Q2, embodiments of the present invention may use air core transformers in some implementations in place of solid core (e.g., ferrite core) transformers. In alternative embodiments, solid core transformers may be used. The transformer used is not limited by the invention.

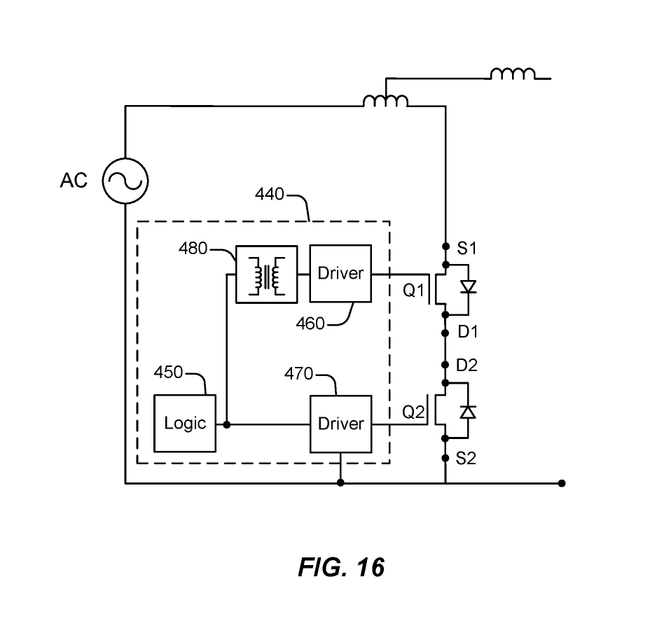

FIG. 16 is a simplified schematic diagram of a circuit including logic driving circuit 440, which is connected to AC-DC converter circuit 400 according to an embodiment of the present invention. In the embodiment illustrated in FIG. 16, a single logic circuit 450 is used to drive two driver circuits 460 and 470.

Logic circuit 450 is configured to generate a logic signal corresponding with the PWM signals to be provided to transistors Q1 and Q2.

As shown, the generated logic signal is provided to driver circuits 460 and 470, where the generated logic signal is provided to driver circuit 460 via isolation device 480. The isolation device 480 can be magnetic, optical, or the like.

Accordingly, in the embodiment illustrated in FIG. 16, transistors Q1 and Q2 are driven by two driver circuits 460 and 470, which are driven by a single logic circuit 450.

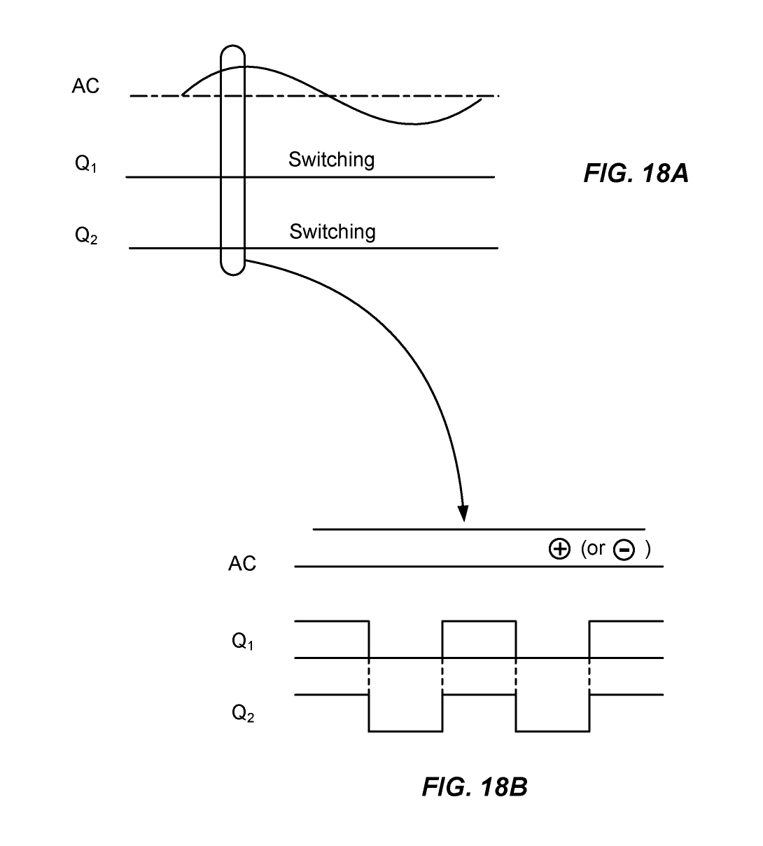

The operation of the embodiment illustrated in FIG. 16 is discussed below with reference to FIGS. 18A and 18B, which are simplified timing diagrams illustrating resonant operation of the AC-DC converter circuit.

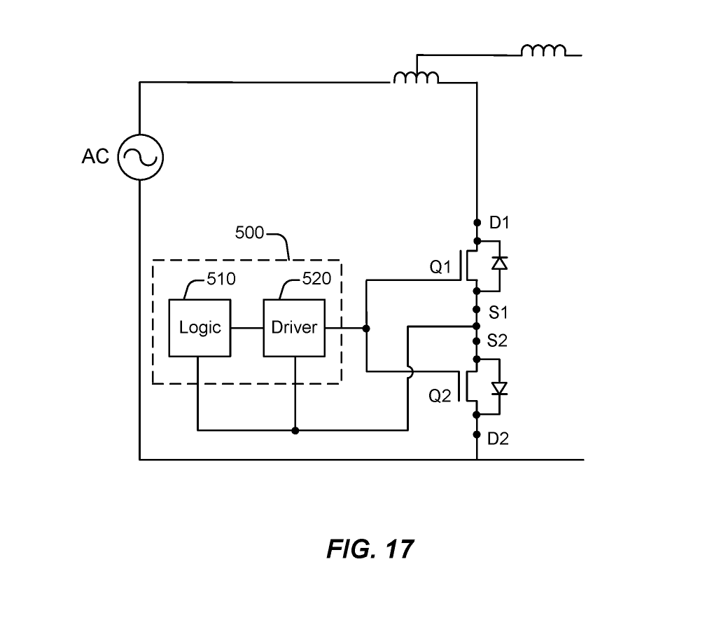

FIG. 17 is a simplified schematic diagram of a circuit including logic driving circuit 500, which is connected to AC-DC converter circuit similar to AC-DC converter circuit 400 according to an embodiment of the present invention. In the embodiment illustrated in FIG. 17, the transistors Q1 and Q2 are configured in a source-to-source configuration. In this configuration, the source S1 of transistor Q1 is connected to the source S2 of transistor Q2. The drain D1 of transistor D1 is connected to the power transformer and the drain D2 of transistor Q2 is connected to ground. As shown, a single logic circuit 510 is used to drive a single driver circuit 520.

Logic circuit 510 is configured to generate a logic signal corresponding with the PWM signals to be provided to transistors Q1 and Q2. As shown, the generated logic signal is provided to driver circuit 520, which drives both transistors Q1 and Q2.

Accordingly, in the embodiment illustrated in FIG. 17, transistors Q1 and Q2 are driven by one driver circuit 520, which is driven by a single logic circuit 510.

The operation of the embodiment illustrated in FIG. 17 is discussed below with reference to FIGS. 18A and 18B.

As described in relation to FIGS. 18A and 18B, the transistors Q1 and Q2 in FIGS. 16 and 17 are driven according to the following protocol.

| | | |
|---|---|---|
| AC | Q1 | Q2 |

| | |
|---|---|
| Positive Portion of Cycle | Synchronized PWM Switching |
| Negative Portion of Cycle | Synchronized PWM Switching |

As illustrated in FIG. 18A, both transistors Q1 and Q2 are switching during both the positive portion of the AC cycle as well as during the negative portion of the AC cycle.

FIG. 18B is an expanded timing diagram illustrating an expanded time period of the timing diagram illustrated in FIG. 18A. As illustrated in FIG. 18B, which corresponds to a positive portion of the AC cycle, the transistors are switched on and off in a synchronous manner (i.e. substantially in phase with each other). As shown, the edges of the signals that are provided to the gates are substantially aligned in time. Similar switching behavior is generated during the negative portion of the AC cycle. Switching frequencies as discussed in relation to FIG. 15B are applicable to the switching behavior illustrated in FIG. 15B.

As a result of the topology of AC-DC converter circuit 400, fewer components are used that in conventional AC-DC power converter circuits, there is less power loss, and a power factor correction circuit is not necessary, and therefore, is not used.

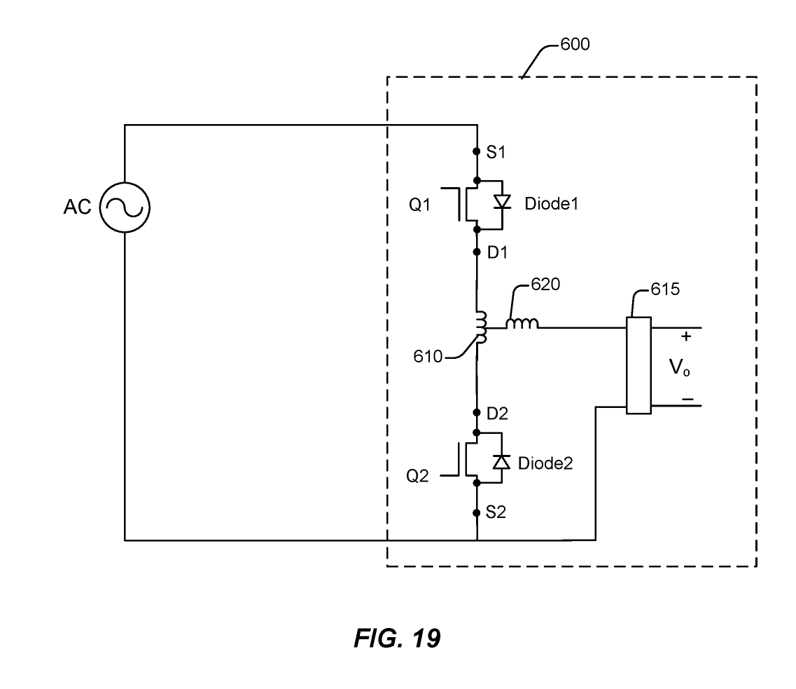

FIG. 19 is a simplified schematic diagram of an AC-DC converter circuit 600 with a FET-inductor-FET configuration according to an embodiment of the present invention. Receiving an AC input signal, the AC-DC converter circuit 600 generates a secondary AC signal which is rectified by rectifier 615 to generate a DC output voltage across Vo. As illustrated in FIG. 19, an AC source voltage is applied across the tapped inductor 610 and transistors Q1 and Q2. In response to the AC source voltage, the series connected tapped inductor 610 and transistors Q1 and Q2 generates the secondary AC signal. Body diodes Diode1 and Diode2 are illustrated along with the source S1, gate G1, and drain D1 of transistor Q1 and the source S2, gate G2, and drain D2 of transistor Q2.

Rectifier 615 may comprise any rectification circuit. For example, rectifier 615 may comprise any of: a single diode rectifier, a full-bridge rectifier, a voltage doubler rectifier, and another type of rectifier.

In this embodiment, AC-DC converter circuit 600 includes an inductor 612 between inductor 610 and rectifier 615. As understood by those of skill in the art, the sizes of inductors 610 and 612 may be selected to maximize resonance.

The AC-DC converter in FIG. 19 does not have an input rectifier, such as input rectifier 20 of AC-DC converter circuit 10, illustrated in FIG. 1. In some embodiments, the transistors Q1 and Q2 are GaN-based transistors that have small parasitics, which enable resonant operation of the circuit.

As shown, the AC-DC converter circuit 600 includes rectifier 615, which receives the AC output from inductor 610 and generates a substantially DC signal across Vo based on the received AC output.

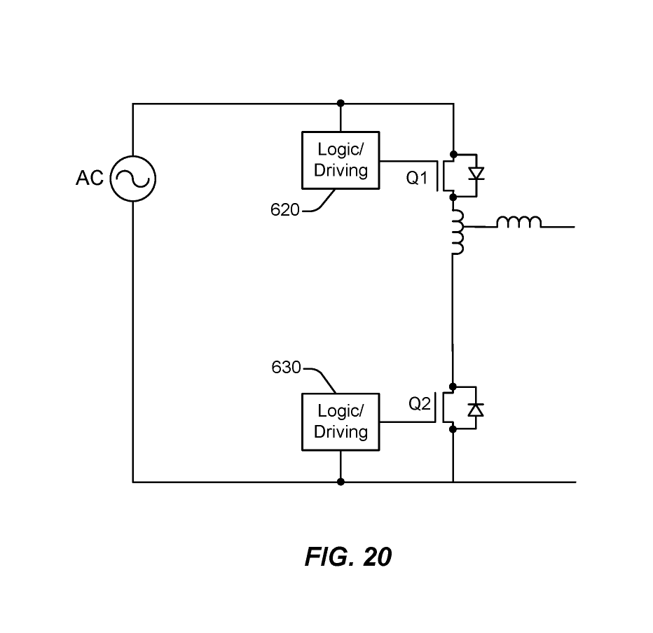

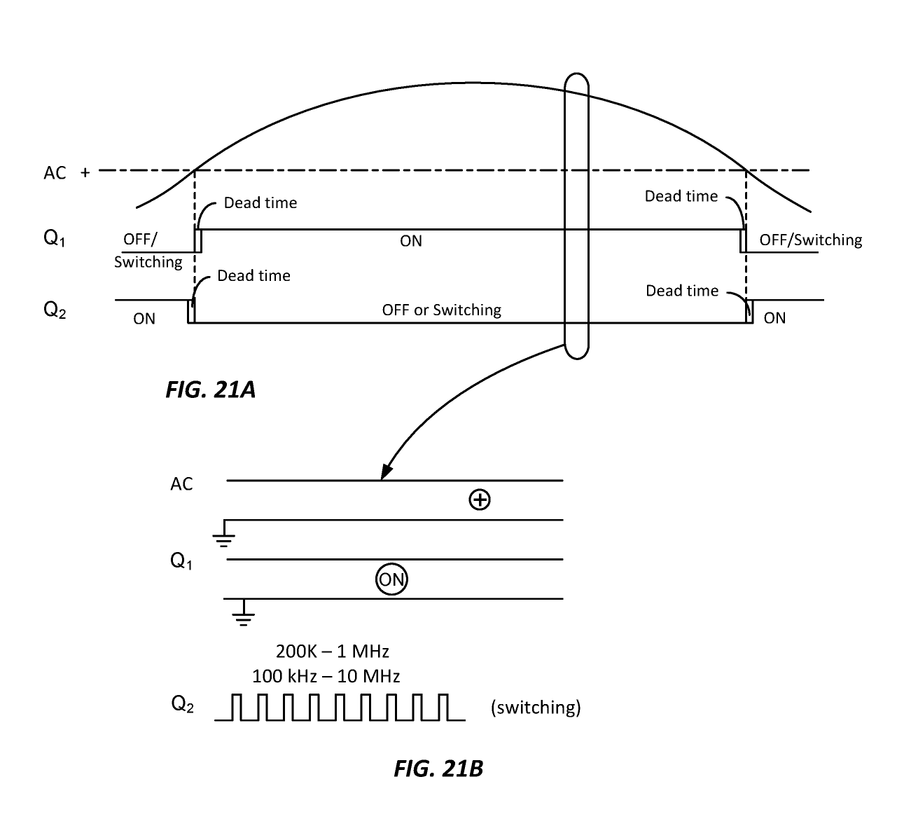

The operation of AC-DC converter circuit 600 is discussed below with reference to FIGS. 20 and 21A/21B.

FIG. 20 is a simplified schematic diagram of a circuit including logic driving circuits 620 and 630, which are connected to AC-DC converter circuit 600 according to an embodiment of the present invention. As shown, logic driving circuit 620 is configured to drive transistor Q1 and logic driving circuit 630 is configured to drive transistor Q2. In some embodiments, logic driving circuits 620 and 630 are substantially identical.

As described with reference to FIGS. 21A and 21B below, the transistors Q1 and Q2 of AC-DC converter circuit 600 are driven according to the following protocol.

| AC | Q1 | Q2 |
|---|---|---|
| Positive Portion of Cycle | ON | PWM Switching |
| Negative Portion of Cycle | PWM Switching | ON |

FIG. 21A is a simplified timing diagram illustrating resonant operation of AC-DC converter circuit 600 driven by logic driving circuits 620 and 630, as illustrated in FIG. 20. As illustrated in FIG. 21A, on the positive portion of the AC source cycle, logic driving circuit 620 turns on transistor Q1 with a PWM signal and logic driving circuit 630 turns off transistor Q2. Referring to FIG. 21A, when the AC source transitions from negative to positive, a short dead time is present for Q1 where Q1 is off for a short duration following the transition. Q2 is also off during a dead time preceding the transition. This ensures that Q1 and Q2 are not both on at the same time.

In some embodiments, Q1 and Q2 dead times overlap such that both transistors Q1 and Q2 are off at zero crossings of the AC source to ensure that transistors Q1 and Q2 are not both on at the same time around transitions from the negative to the positive portion of the cycle. Other dead time transitions may also be implemented which ensure that transistors Q1 and Q2 are not both on at the same time around transitions from the negative to the positive portion of the cycle.

In this embodiment, as the AC source transitions from the positive portion of the cycle to the negative portion of the cycle, dead times are similarly provided for transistors Q1 and Q2. During the transition from the positive to the negative portion of the cycle, transistor Q1 is off during a short time preceding the transition and transistor Q2 is off for a short time following the transition. Other dead time transitions may also be implemented which ensure that transistors Q1 and Q2 are not both on at the same time around transitions from the positive portion to the negative portion of the cycle.

FIG. 21B is an expanded timing diagram illustrating an expanded time period of the timing diagram of FIG. 21A. As illustrated in FIG. 21B, during the positive portion of the AC cycle, in response to respective PWM signals from logic driving circuits 620 and 630, transistor Q1 is held in an on state and transistor Q2 is alternating between on and off states at a frequency than ranges from about 100 kHz to about 10 MHz. In a particular embodiment, the switching frequency of transistor Q2 is from about 200 kHz to about 1 MHz. In alternative embodiments, Q2 switches between on and off states at other frequencies.

Corresponding switching behavior is applied to transistor Q1 during the negative portion of the AC cycle, when transistor Q2 is held in an on state and transistor Q1 alternates between on and off states.

Because of the high switching frequencies enabled by the use of GaN transistors as transistors Q1 and Q2, embodiments of the present invention may use air core transformers in some implementations in place of solid core (e.g., ferrite core) transformers. In alternative embodiments, solid core transformers may be used. The transformer used is not limited by the invention.

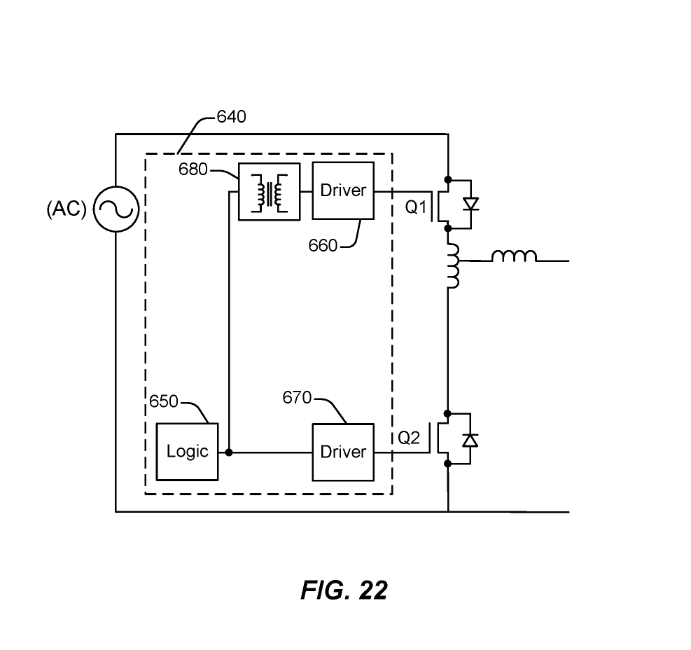

FIG. 22 is a simplified schematic diagram of a circuit including logic driving circuit. 640, which is connected to AC-DC converter circuit 600 according to an embodiment of the present invention. In the embodiment illustrated in FIG. 22, a single logic circuit 650 is used to drive two driver circuits 660 and 670.

Logic circuit 650 is configured to generate a logic signal corresponding with the PWM signals to be provided to transistors Q1 and Q2.

As shown, the generated logic signal is provided to driver circuits 660 and 670, where the generated logic signal is provided to driver circuit 660 via isolation device 680. The isolation device 680 can be magnetic, optical, or the like.

Accordingly, in the embodiment illustrated in FIG. 22, transistors Q1 and Q2 are driven by two driver circuits 660 and 670, which are driven by a single logic circuit 650.

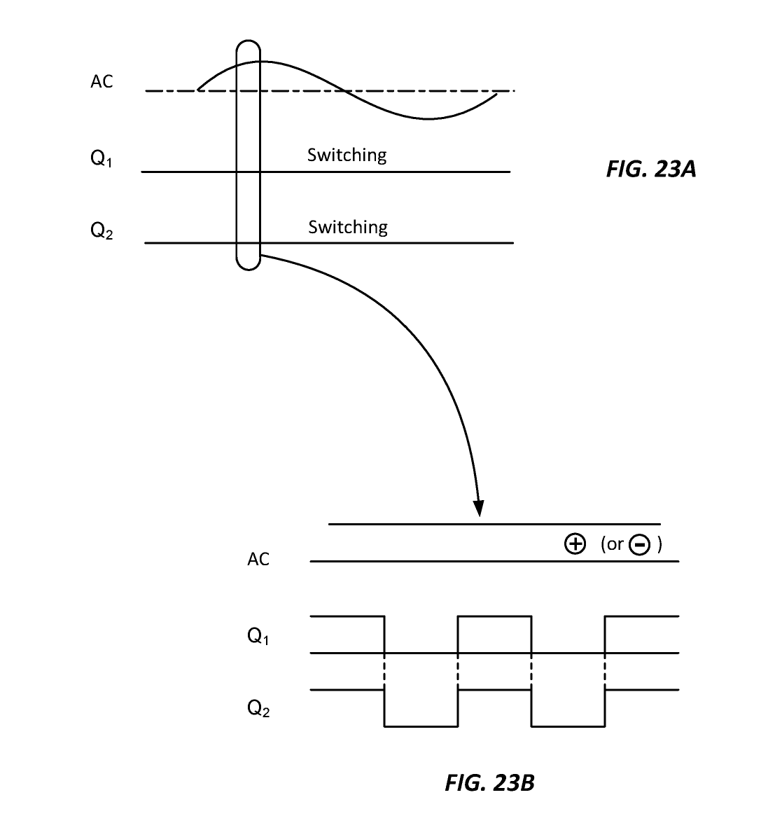

The operation of the embodiment illustrated in FIG. 22 is discussed below with reference to FIGS. 23A and 23B, which are simplified timing diagrams illustrating resonant operation of the AC-DC converter circuit. In the operation of the embodiment illustrated in FIG. 22, transistors Q1 and Q2 are driven according to the following protocol.

| | | |
|---|---|---|
| AC | Q1 | Q2 |

| | |
|---|---|
| Positive Portion of Cycle | Synchronized PWM Switching |
| Negative Portion of Cycle | Synchronized PWM Switching |

As illustrated in FIG. 23A, both transistors Q1 and Q2 are switching during both the positive portion of the AC cycle as well as during the negative portion of the AC cycle.

FIG. 23B is an expanded timing diagram illustrating an expanded time period of the timing diagram illustrated in FIG. 23A. As illustrated in FIG. 23B, which corresponds to a positive portion of the AC cycle, the transistors are switched on and off in a synchronous manner (i.e. substantially in phase with each other). As shown, the edges of the signals that are provided to the gates are substantially aligned in time. Similar switching behavior is generated during the negative portion of the AC cycle. Switching frequencies as discussed in relation to FIG. 21B are applicable to the switching behavior illustrated in FIG. 21B.

As a result of the topology of AC-DC converter circuit 600, fewer components are used that in conventional AC-DC power converter circuits, there is less power loss, and a power factor correction circuit is not necessary, and therefore, is not used.

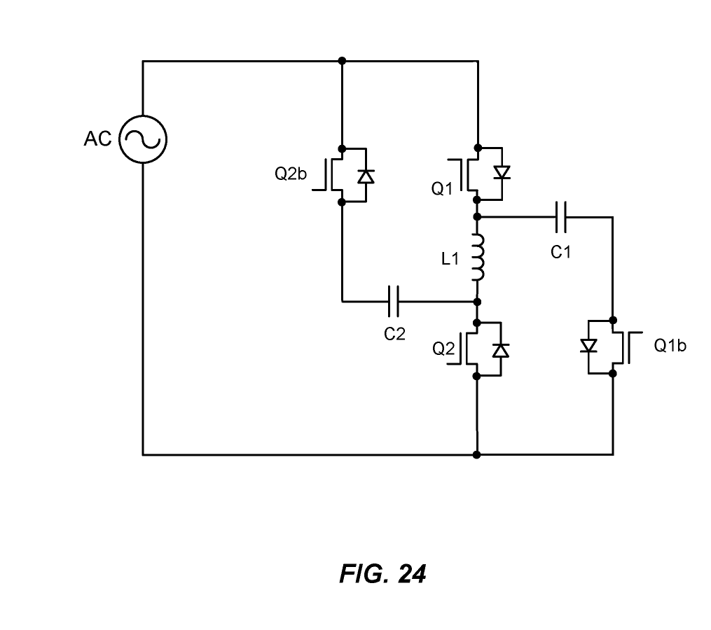

FIG. 24 is a simplified schematic diagram of a clamp circuit 700 according to an embodiment of the present invention. As a result of noise or other coupling in AC-DC converter circuits, an overvoltage may occur. Clamp circuit 700 includes transistors Q1, Q1b, Q2, Q2b, and capacitors C1 and C2. As shown, clamp circuit 700 is connected to an AC source and to inductor L1. L1 schematically represents an inductive component, for example, in an AC-DC converter circuit. For example, L1 may represent the primary inductor of power transformers 110 and/or 310 of FIGS. 2 and 8 and/or the inductors 410 and/or 610 of FIGS. 13 and 19.

The operation of the embodiment illustrated in FIG. 24 is discussed below. In the operation of the embodiment illustrated in FIG. 24, transistors Q1 and Q2 may be driven according to the one of the protocols discussed above. In addition, transistors Q1 and Q2 transistors Q1 and Q2 are driven according to driven according to following protocol.

| AC | Q1b | Q2b |
|---|---|---|
| Positive Portion of Cycle | OFF | Enabled |
| Negative Portion of Cycle | Enabled | OFF |

Accordingly, because transistors Q1 and Q2b are enabled during the positive portion of the cycle, at the beginning of the positive portion of the cycle, capacitor C1 is substantially discharged. As the positive portion of the cycle continues, the voltage at the transistor Q1 side of capacitor C1 ideally increases according to the AC voltage at the source of transistor Q1. However, if an overvoltage were to occur at the transistor Q1 side of capacitor C1, the overvoltage is coupled by the capacitor C1 to the source of transistor Q2 through the body diode of transistor Q1b, which is off. As a result, the overvoltage is clamped by the body diode of transistor Q1b to the voltage at the source of transistor Q2 plus the voltage threshold of the body diode of transistor Q1b.

Accordingly, because transistors Q2 and Q1b are enabled during the negative portion of the cycle, at the beginning of the negative portion of the cycle, capacitor C2 is substantially discharged. As the negative portion of the cycle continues, the voltage at the transistor Q2 side of capacitor C2 ideally increases according to the AC voltage at the source of transistor Q2. However, if an overvoltage were to occur at the transistor Q2 side of capacitor C2, the overvoltage is coupled by the capacitor C2 to the source of transistor Q1 through the body diode of transistor Q2b, which is off. As a result, the overvoltage is clamped by the body diode of transistor Q2b to the voltage at the source of transistor Q1 plus the voltage threshold of the body diode of transistor Q2b.

It is also understood that the examples and embodiments described herein are for illustrative purposes only and that various modifications or changes in light thereof will be suggested to persons skilled in the art and are to be included within the spirit and purview of this application and scope of the appended claims.

What is claimed is:

1. An AC-DC converter configured to convert an input AC signal to an output DC signal, the AC-DC converter comprising:
an inductor;
first and second transistors;
wherein the inductor and first and second transistors are connected in series with one another, wherein the input AC signal is applied across the series connected inductor and first and second transistors, and wherein the series connected inductor and first and second transistors is configured to generate a secondary AC signal based on the AC input signal; and
a rectifier, configured to rectify a signal based on the secondary AC signal to generate a substantially DC output signal based on the AC input signal.

2. The AC-DC converter of claim 1, wherein the first and second transistors comprise GaN-based transistors.

3. The AC-DC converter of claim 1, wherein the first and second transistors are adjacent in the series connected inductor and first and second transistors.

4. The AC-DC converter of claim 3, wherein the inductor is a primary inductor in a transformer, and wherein the transformer is configured to cooperatively generate the secondary AC signal with the first and second transistors.

5. The AC-DC converter of claim 4, further comprising a driving circuit configured to drive the first and second signals such that during a positive portion of a cycle of the input signal, the first transistor is turned on and the second transistor is turned on according to a first PWM signal, and such that during a negative portion of a cycle of the input signal, the second transistor is turned on and the first transistor is turned on according to a second PWM signal.

6. The AC-DC converter of claim 4, further comprising a driving circuit configured to drive the first and second signals such that the first and second transistors are turned on according to a single PWM signal.

7. The AC-DC converter of claim 3, wherein the inductor comprises a tapped inductor.

8. The AC-DC converter of claim 7, further comprising a driving circuit configured to drive the first and second signals such that during a positive portion of a cycle of the input signal, the first transistor is turned on and the second transistor is turned on according to a first PWM signal, and such that during a negative portion of a cycle of the input signal, the second transistor is turned on and the first transistor is turned on according to a second PWM signal.

9. The AC-DC converter of claim 7, further comprising a driving circuit configured to drive the first and second signals such that the first and second transistors are turned on according to a single PWM signal.

10. The AC-DC converter of claim 7, further comprising a second inductor connected between the tapped inductor and the rectifier, wherein the second inductor is configured to cooperatively generate the secondary AC signal with the tapped inductor and the first and second transistors.

11. The AC-DC converter of claim 1, wherein the inductor is between the first and second transistors in the series connected inductor and first and second transistors.

12. The AC-DC converter of claim 11, wherein the inductor is a primary inductor in a transformer, and wherein the transformer is configured to cooperatively generate the secondary AC signal with the first and second transistors.

13. The AC-DC converter of claim 12, further comprising a driving circuit configured to drive the first and second signals such that during a positive portion of a cycle of the input signal, the first transistor is turned on and the second transistor is turned on according to a first PWM signal, and such that during a negative portion of a cycle of the input signal, the second transistor is turned on and the first transistor is turned on according to a second PWM signal.

14. The AC-DC converter of claim 12, further comprising a driving circuit configured to drive the first and second signals such that the first and second transistors are turned on according to a single PWM signal.

15. The AC-DC converter of claim 11, wherein the inductor comprises a tapped inductor.

16. The AC-DC converter of claim 15, further comprising a driving circuit configured to drive the first and second signals such that during a positive portion of a cycle of the input signal, the first transistor is turned on and the second transistor is turned on according to a first PWM signal, and such that during a negative portion of a cycle of the input signal, the second transistor is turned on and the first transistor is turned on according to a second PWM signal.

17. The AC-DC converter of claim 15, further comprising a driving circuit configured to drive the first and second signals such that the first and second transistors are turned on according to a single PWM signal.

18. The AC-DC converter of claim 15, further comprising a second inductor connected between the tapped inductor and the rectifier, wherein the second inductor is configured to cooperatively generate the secondary AC signal with the tapped inductor and the first and second transistors.

19. The AC-DC converter of claim 1, further comprising a driving circuit configured to drive the first and second signals such that during a positive portion of a cycle of the input signal, the first transistor is turned on and the second transistor is turned on according to a first PWM signal, and such that during a negative portion of a cycle of the input signal, the second transistor is turned on and the first transistor is turned on according to a second PWM signal.

20. The AC-DC converter of claim 1, further comprising a driving circuit configured to drive the first and second signals such that the first and second transistors are turned on according to a single PWM signal.
